(19) United States
(12) Patent Application Publication
(10) Pub. No.: US 2012/0054350 A1
(43) Pub. Date: Mar. 1, 2012

(54) APPARATUS FOR COUPLING BETWEEN NETWORK USERS

(75) Inventor: Noam GAZIT, Tel-Aviv (IL)

(73) Assignee: S.G.Z.LTD., Tel-Aviv (IL)

(21) Appl. No.: 12/870,823

(22) Filed: Aug. 29, 2010

Related U.S. Application Data
(60) Provisional application No. 61/372,883, filed on Aug. 12, 2010.

(51) Int. Cl. G06F 15/16

(52) U.S. Cl. 709/227

(57) ABSTRACT

The subject matter discloses a computerized apparatus (100) configured for coupling between network users, the apparatus comprising a receiver (110) configured for receiving a first coupling request from a first user to a second user; a processor (120) configured for searching for a second coupling request from the second user to the first user according to the addresses; a storage device (140) for storing in the buffer the first coupling request as a result of not finding the second coupling request; and a transmitter (130) for sending a coupling message to the first user and to the second user according to information stored in the buffer, as a result of finding the second coupling request.

### BACKGROUND

The present disclosure relates to network applications, in general, and to internet applications for coupling between two or more entities in particular.

Network applications for coupling between two or more entities are known in the art. Such enteritis may be people, organization and the like. Such applications may be for example Facebook, LinkedIn, applications for creating connections between a man and a woman and the like. Other applications may be for example, applications for closing a deal over the network between a seller and a buyer. Such application may be performed via the internet by using a computerized device. The computerized device may be a computer, a cellular telephone and the like. Other application that enable to connect between two entities may be SMS messaging, email messaging and the like.

In such an application, a user may send a coupling request directly to the other user. The other user may send a response or may ignore the request message.

### BRIEF SUMMARY OF THE INVENTION

One exemplary embodiment of the disclosed subject matter is a computerized apparatus configured for coupling between network users. The computerized apparatus comprising a receiver configured for receiving a first coupling request from a first user to a second user, a processor configured for searching in a storage for a second coupling request from the second user to the first user, a storage device for storing in the storage the first coupling request as a result of not finding the second coupling request and a transmitter for sending a coupling message to the first user and to the second user according to an information stored in the storage, as a result of finding the second coupling request. The apparatus further comprising a communication driver for the receiving the first coupling request and the second coupling request and for the transmitting the coupling message over the network. The processor is further configured for extracting a first address of the first user and extracting a second address of the second user from the first coupling request for being used for the searching and for the sending. The processor is further configured for extracting a content from the first coupling request for being saved in the storage and for being embedded in the coupling message. The first coupling request, the second coupling request and the coupling message is Short Message Service. The apparatus of claim 1, wherein the storage comprises a buffer.

Another exemplary embodiment of the disclosed subject matter is a method for performing coupling between network users. The method comprising receiving a first coupling request from a first user to a second user; searching in a storage for a second coupling request from the second user to the first user; storing in the storage the first coupling request as a result of not finding the second coupling request; and transmitting a coupling message to the first user and to the second user as a result of finding the second coupling request in the storage. The method further comprising extracting a first address of the first user and extracting a second address of the second user for being used for the searching and for the transmitting. The method further comprising extracting content from the first coupling request for being stored in the storage and for being embedded in the coupling message. The method storage comprises a buffer.

Another exemplary embodiment of the disclosed subject matter a computer program placed on a magnetic readable media for coupling between network users, the computer program comprising a first program instruction for receiving a first coupling request from a first user to a second user; a second program instruction for searching in a storage for a second coupling request from the second user to the first user; a third program instruction for storing in the storage the first coupling request as a result of not finding the second coupling request; and a forth program instruction for transmitting a coupling message to the first user and to the second user as a result of finding the second coupling request in the storage; wherein the first, second third and forth program instructions are stored on a computer readable medium.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a block diagram of a computerized apparatus configured for coupling between network users, in accordance with some exemplary embodiments of the disclosed subject matter;

FIG. 2 shows flowchart diagram of a method for coupling between network users, in accordance with some exemplary embodiments of the disclosed subject matter;

FIG. 3 shows a flowchart diagram of a method for sending a coupling message, in accordance with some exemplary embodiments of the disclosed subject matter; and

FIG. 4 shows a flowchart diagram of a method for removing old messages from the storage, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with by the disclosed subject matter is to enable a first user of a computerized apparatus that is connected to a network to send a coupling request to a second user over the network, wherein the coupling request from the first user to the second user is disclosed to the second user only when the second user initiate a coupling request to the first user and wherein the sending of the message may be done from existing network applications such as email or SMS and the like, and wherein the sending may be done without the need to register to the service and for without the need to download a dedicated software.

Such a problem may occur for example when a user of a computerized apparatus, wishes to sends a message for starting a communication with a second user of a computerized apparatus but would like to keep this message private if the second person is not interested in starting the communication. The computerized apparatus may be a cellular telephone, a laptop, a personal computer and the like.

One exemplary scenario may be when a man whishes to start a relationship with a woman but is interested that the woman will not know about this wish unless she is also interested in the relationship. According to one exemplary embodiment, the man may send a request message to the woman. The request message may be delivered to the woman if the woman also sends a request message to the man. If both the man and the woman send a request, the apparatus of the present subject matter send both the man and the woman a message informing them that the other person is also interested in starting a relationship. If only one of the persons (either the man or the women in this example) sends a request message, the message is not delivered to the other side. Another exemplary scenario may be, for example, when a seller wishes to sell an item for a certain price. In such a case, the request for selling the item for a certain price may only be delivered to the buyer if the buyer wishes to buy the item for the offered price. Another exemplary scenario may occur when a buyer wishes to make an offer to a seller. The request may be sent from an internet application, as a Short Message Service (SMS) message, as an email message and the like.

One technical solution may comprise a computerized machine. The computerized machine may be a server. The computerized machine may comprise a receiver configured for receiving a first coupling request from a first user to a second user, a processor configured for searching in a buffer for a second coupling request from the second user to the first user, a transmitter configured for sending a coupling message to the first user and to the second user if the second coupling request is found, a storage device for storing in the buffer the first request when the second request is not found and one or more communication driver for the receiving the first coupling request and for the transmitting the coupling request. The coupling request may be an SMS message send from a cellular telephone, an email message or another network based application message. According to some embodiments, a coupling request from a first user (user A) to a second user (user B) B may be sent to the computerized machine and may comprise the destination of user B and a content to be sent to user B and a coupling request from user B to user A may be sent to the computerized machine and may comprise the destination of user A and a content to be sent to user A. The destination of the users may be a cellular number. The matching message may be sent from the computerized device to user A and user B and may comprise the content that was embedded in the coupling request. Thus there is no need to download software to the cellular telephone of user A and user and there is no need to register to the service prior to using the service.

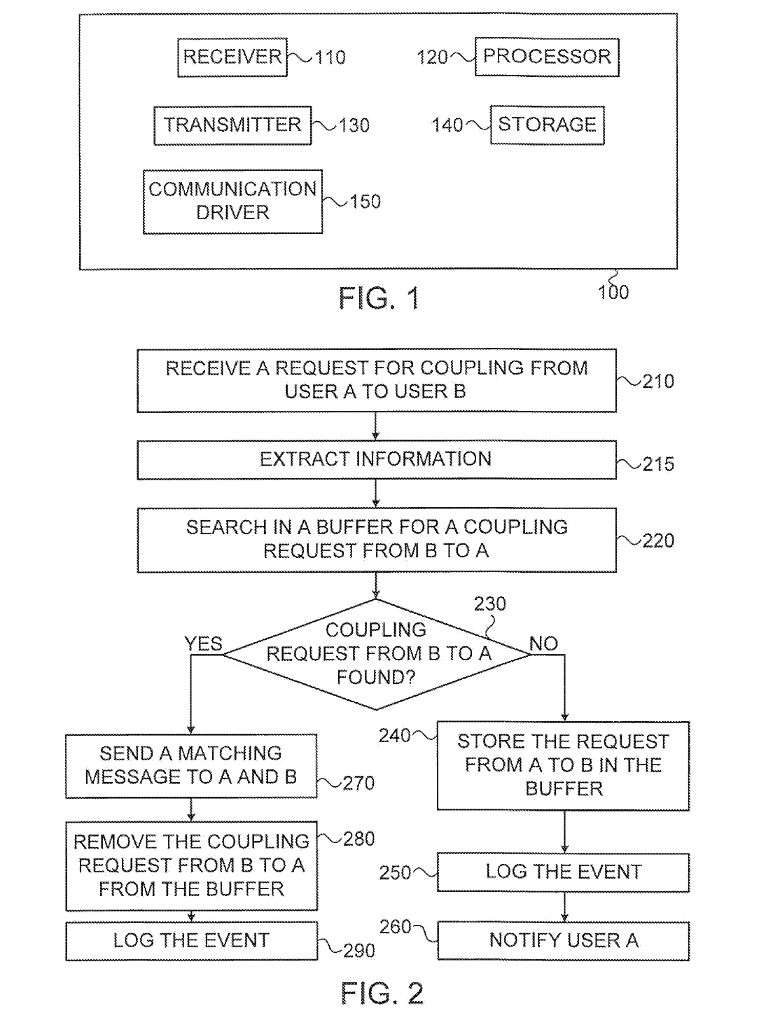

Referring now to FIG. 1 showing a block diagram of a computerized apparatus configured for coupling between network users, in accordance with some exemplary embodiments of the subject matter. A computerized apparatus 100 may be a server.

The computerized apparatus 100 may comprise a receiver 110 configured for receiving a first coupling request from a first user to a second user. The first coupling request may be an SMS message an email message and the like. The SMS message may comprise the telephone number of the second user and may also comprise a content to be transfer to the second user when the match is found.

The computerized apparatus 100 comprises a processor 120 configured for searching in a buffer for a second coupling request. The second coupling request is from the second user to the first user. The processor 120 may also be configured for analyzing a coupling message for extracting the address of user A and the address of user B and for extracting the content. The address may be, for example a cellular telephone. In such a case the coupling request is sent as an SMS message.

The computerized apparatus 100 may also comprise a transmitter 130 configured for sending a coupling message and other notification messages to the first user and to the second user. The coupling message may be set only if the second coupling request is found. The coupling message to the first user may comprise a content that was sent in the coupling message from the second user to the first user. The coupling message to the second user may comprise a content that was sent in the coupling message from the first user to the second user. The coupling message is sent to the addresses that are saved in the buffer.

The computerized apparatus 100 may also comprise a storage device 140 configured for storing in the buffer the first request when the second request is not found. The storage device 140 may be a hard-disk or flash memory and the like.

The computerized apparatus 100 may also comprise one or more communication drivers shown, for the purpose of illustration only, as communication driver 150. The communication driver 150 may be configured for receiving the first coupling request and for transmitting the coupling request or other notification requests over the network. Each communication driver shown as communication driver 150 may be a driver capable for receiving and transmitting SMS messages, a driver capable for receiving and transmitting internet messages and the like. Thus, the computerized apparatus 100 may handle various types of messages.

FIG. 2 shows a flowchart diagram of a method for coupling between network users, in accordance with some exemplary embodiments of the disclosed subject matter.

In step 210, a request for coupling user A to user B may be received. Such a request may be for example an SMS message directed to user B.

In step 215, information may be extracted from the request. The information may comprise the destination indicator of user B and of user A and a content to be transmitted to user B when a match is found. The destination indicator may be a cellular telephone number, an email address and the like. The content may be any free text; for example, the free text may be “I would like to meet you at 11 PM”. The content may be a picture and the like.

In step 220, a search may be performed on a storage. The storage may be a hard disk or any other media suitable for storage of information and/or data. The storage may comprise a buffer. The buffer may comprise a list of coupling request messages that have not been coupled yet. A coupling request message that is not coupled may be, for example, a request message from user A to user B wherein a request from user B to user A has not been received yet. The search may comprise a hash function; the keys may comprise the addresses of user A and user B. The storage may comprise a content associated with each coupling request. The storage may comprise an indication of content associated with each coupling request. An indication of content associated with each coupling request may comprise an address where the content is located, a reference to the content or the content location, a shortened version or encrypted version of the content and the like.

Steps 240-260 may be performed if a coupled request from user B to user A has not been found at the time of the search performed in step 220

In step 240, the information extracted from the coupling request from user A to user B may be stored in the buffer. The request is stored in order to enable to find a match if a request from user B to user A is received. The stored request may comprise the address of user A, the address of user B and the text to be sent to user B when a match is found. The address may be a cellular telephone number, for example. The stored request may also comprise a time stamp for storing the time of the storage and for enabling the removal of an old message as explained in greater details in FIG. 4.

In step 250, the event may be logged. In step 260, user A may be notified about not finding a match as of the time of the search performed in step 220.

Steps 270-290 may be performed if a coupling request from user B to user A has been found. In step 270, a coupling message may be sent to user A and to user B. Such a coupling message may indicate that both user A and user B are interested to be coupled. Such a coupling message may indicate that both user A and user B are interested to be connected, have a mutual interest, a mutual transaction and the like. The coupling message to user A may comprise content sent from user B to user A. The coupling message to user B may comprise content sent from user A to user B.

In step 280, the coupling request from user B to user A may be removed from the buffer, since the match was found during the search performed in step 220.

In step 290, the event of finding a coupling request from user B to user A may be logged.

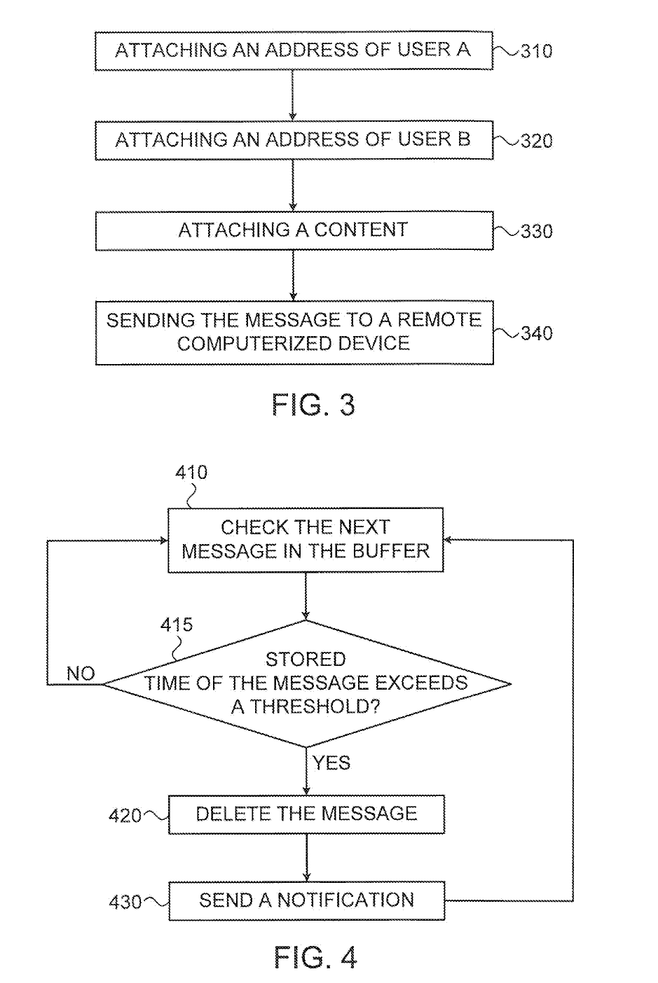

FIG. 3 shows a flowchart diagram of a method for sending a coupling message from user A to user B, in accordance with some exemplary embodiments of the disclosed subject matter.

In step 310, the address of user B may be attached to a message. The message may be any network message, such as an SMS message, for example. The address may be a cellular telephone number, an email message, any other network address a cellular or landline telephone number, which may have additional digits or characters or other signs, a sequence of sounds generated by a computerized device, an instant message, a sequence of transmissions, a sequence of data items transmitted or broadcasted, and the like.

In step 320, the address of user A may be attached to a message. The message may be any network message, such as an SMS message, for example. The address may be a cellular telephone number, an email message address, a network address, a landline telephone number, a computer or router address, a sequence of data or information representing an address, and the like. In some exemplary embodiments, the address of user A is not attached since the address can be extracted from the message itself. For example in the case of an SMS message, the address can be extracted from the header of the message.

In step 330, a content may be attached to the message. The content may be text, a picture and the like. In the case of a SMS message, a text content may be attached. In some embodiments of the subject matter, the message will not comprise content, just an address to be sent. In some embodiments of the present invention the content may be an indication (such as an additional digit or character and the like) that a request is sent from user A to user B or vice versa with the intent to form a relationship or perform a transaction.

In step 340, the message may be sent to a remote computerized device for coupling between this message and a coupling message from user B to user A as was further described in detail in connection with the description of FIG. 2.

The addresses and the content may be attached in a predefined format. The predefined format may be known to the remote computerized device and may be used by the remote computerized device for extracting the addresses and the content from the message.

FIG. 4 shows a flowchart diagram of a method for removing old messages from the storage, in accordance with some exemplary embodiments of the disclosed subject matter. The method may be used for avoiding a coupling with an old request wherein the old request may be irrelevant. The process may go over all the messages the in the buffer in order to remove old messages. In step 410 the next message is checked. Steps 420 and 430 may be performed after a check in step 415 has found that the stored time of the message exceeds a threshold. In step 420, the message may be removed from the buffer. In step 430, a notification about the removal may be sent to the initiator of the message.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computerized apparatus configured for coupling between network users comprising:
a receiver configured for receiving a first coupling request from a first user to a second user;
a processor configured for searching in a storage for a second coupling request from the second user to the first user;
a storage device for storing in the storage the first coupling request as a result of not finding the second coupling request; and
a transmitter for sending a coupling message to the first user and to the second user according to an information stored in the storage, as a result of finding the second coupling request.

2. The apparatus of claim 1, further comprising a communication driver for the receiving the first coupling request and the second coupling request and for the transmitting the coupling message over the network.

3. The apparatus of claim 1, wherein the processor is further configured for extracting a first address of the first user and extracting a second address of the second user from the first coupling request for being used for the searching and for the sending.

4. The apparatus of claim 1, wherein the processor is further configured for extracting a content from the first coupling request for being saved in the storage and for being embedded in the coupling message.

5. The apparatus of claim 1, wherein the first coupling request, the second coupling request and the coupling message is Short Message Service.

6. The apparatus of claim 1, wherein the storage comprises a buffer,

7. A method for performing coupling between network users, comprising:
a. receiving a first coupling request from a first user to a second user;
b. searching in a storage for a second coupling request from the second user to the first user;
c. storing in the storage the first coupling request as a result of not finding the second coupling request; and
d. transmitting a coupling message to the first user and to the second user as a result of finding the second coupling request in the storage.

8. The method of claim 7, further comprising extracting a first address of the first user and extracting a second address of the second user for being used for the searching and for the transmitting.

9. The method of claim 7, further comprising extracting a content from the first coupling request for being stored in the storage and for being embedded in the coupling message.

10. The method of claim 7, wherein the storage is a buffer.

11. A computer program placed on a magnetic readable media for coupling between network users, the computer program comprising:
a first program instruction for receiving a first coupling request from a first user to a second user;
a second program instruction for searching in a storage for a second coupling request from the second user to the first user;
a third program instruction for storing in the storage the first coupling request as a result of not finding the second coupling request; and
a fourth program instruction for transmitting a coupling message to the first user and to the second user as a result of finding the second coupling request in the storage; wherein the first, second third and fourth program instructions are stored on a computer readable medium.
